(19) United States
(12) Patent Application Publication
(10) Pub. No.: US 2005/0207445 A1
(43) Pub. Date: Sep. 22, 2005

(54) Data input device and data output device for data driven processor, and methods therefor

(75) Inventor: Seiichiro Kihara, Katsuragi-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/080,535

(22) Filed: Mar. 16, 2005

(30) Foreign Application Priority Data
Mar. 17, 2004 (JP) 2004-076721(P)

(51) Int. Cl. H04J 3/16

(52) U.S. Cl. 370/470

(57) ABSTRACT

A counter generates a generation number based on an input data valid signal and a frame end signal. When a packet generating circuit generates a packet from the generation number generated by the counter and data of a prescribed length generated by dividing variable length data, it refers to the frame end signal to determine whether the data corresponds to a last sequence of a frame. When it corresponds to the last sequence, the packet generating circuit stores in the relevant packet a node number that differs from the node number being stored in a packet containing data corresponding to a sequence other than the last sequence. This enables the data driven processor to execute a particular program for the packet corresponding to the last sequence, thereby suppressing a decrease in processing speed of the data driven processor.

This nonprovisional application is based on Japanese Patent Application No. 2004-076721 filed with the Japan Patent Office on Mar. 17, 2004, the entire contents of which are hereby incorporated by reference.

### BACKGROUND OF THE INVENTION

1. Field of the Invention

The present invention relates to a data input device that transforms externally input data to data for use in a data driven processor and outputs the same, and a data output device that transforms the data from the data driven processor and externally outputs the same. More particularly, the present invention relates to a data input device that transforms data having variable data length to an internal packet for a data driven processor, a data output device that externally outputs the internal packet for the data driven processor as variable length data, and methods therefor.

2. Description of the Background Art

In recent years, there has been an increasing demand for improved processor performance in various fields of multimedia processing, high-definition image processing and others where fast processing of a large volume of data is required. With the currently available LSI (Large Scale Integrated circuit) manufacturing techniques, however, there is a limit to speeding of devices. Thus, parallel processing has attracted attention, and research and development related thereto have been conducted vigorously.

Among computer architectures suitable for such parallel processing, a data driven architecture has particularly been the focus of attention. In a data driven processing system, processing proceeds in parallel according to a rule that certain processing is carried out only after all the input data necessary for the processing become ready and a resource such as an operation device necessary for the processing is assigned. Japanese Patent Laying-Open Nos. 64-026236, 06-124352, 2002-245025, and 08-329039 disclose techniques related thereto.

A data driven computer disclosed in Japanese Patent Laying-Open No. 64-026236 includes a packet assembly portion that adds tag information to data successively input and having no tag information, in accordance with an externally supplied input/output format select signal, to assemble a packet, an instruction storage portion that stores a processing procedure to be performed on the input data, an arithmetic portion that performs arithmetic processing on the input data in accordance with the processing procedure, and an output control portion that externally outputs the packet having been processed by the arithmetic portion.

A data driven information processing device disclosed in Japanese Patent Laying-Open No. 06-124352 includes an arithmetic portion that performs arithmetic processing in accordance with a data flow program based on a data packet added with a tag, and a tag adding portion that is provided at the input stage of the arithmetic portion. The tag adding portion uniformly adds prescribed tags to data provided as input signals from the outside or from other online-connected information processing devices to generate data packets, which are supplied to the arithmetic portion.

In a data driven information processing device disclosed in Japanese Patent Laying-Open No. 2002-245025, a packet generating portion divides a plurality of generated clocks to generate clocks of different frequencies and selects one of the frequencies. It sets destination information and data in accordance with a selected clock rate, and generates a data packet with the set results stored therein. An input/output control portion takes in the data packet generated by the packet generating portion, and sends it to a program storage portion or a data memory interface portion in accordance with the destination information.

A data driven information processing device disclosed in Japanese Patent Laying-Open No. 08-329039 includes a data packet generating portion that generates a data packet having a tag including a generation number, a destination number, instruction information and a constant value, based on externally input image data. The data packet generating portion includes a generation number generating processing portion that generates a multi-dimensional generation number to be added to the data based on the order of the input image data, and a destination number generating processing portion that generates a tag as a function of the generation number generated by the generation number generating processing portion.

FIG. 1 shows a conventional packet transformation circuit that generates a packet for use in a data driven processor from image data (video signal). The packet transformation circuit 100 extracts image data (Data) in synchronization with a clock signal (Clock). Upon generation of a packet from the extracted image data, it generates a generation number from a horizontal synchronization signal (HSI) and a vertical synchronization signal (VSI) and adds the same to the packet. A register 101 stores information of node number and others to be added to the packet upon generation thereof.

FIG. 2 shows a generation number that is included in a packet generated from a video signal. The generation number is formed of three data items called “pixel”, “line” and “field”. The “pixel” is information indicating a corresponding word within a line. The “line” is information indicating a corresponding line within a field. The “field” is information indicating a corresponding field of the video signal.

When a data driven processor is to process protocol data of Ethernet® or the like, it is necessary to generate a packet by using an Ethernet® frame as data and by adding a generation number thereto. The generation number added at this time is formed of a number (sequence number) that indicates a corresponding word in the Ethernet® frame, a number (frame number) that is assigned for each Ethernet® frame, and a number (interface number) for specifying a corresponding interface when there are a plurality of interfaces for the device, as shown in FIG. 6, corresponding to the pixel, line and field, respectively, of FIG. 2.

FIG. 3 illustrates packets generated from an Ethernet® frame. The packet includes protocol data and a generation number corresponding thereto. In FIG. 3, one frame is formed of 16 words, and for example a first word ((1), (2), (3), (4)) of the protocol data is added with the generation number having the sequence number of “0”, the frame number of “0” and the interface number of “0”.

In video signal processing, it can be considered that the number of lines per field and the number of pixels per line are both fixed. Thus, in a program employing a generation number, the line number and the pixel number for the data at the center of the field, for example, can be handled as constant operands in advance. Further, since the line number and the pixel number for the last data of one field are known in advance, they can be handled as constant operands as well.

According to IEEE (The Institute of Electrical and Electronics Engineers, Inc.) Std 802.3-2002, however, the packet length of Ethernet® is 64 bytes at a minimum and 1522 bytes at a maximum except for a preamble, and the packet length can be set in units of bytes.

As such, it is not possible to predict the packet length of Ethernet® being input to a data driven processor. This means that when processing network protocol data of Ethernet® or the like with a data driven processor, a constant cannot be used for an operand as in the case of the video signal processing.

Specifically, in the case where frame data of Ethernet® having been processed by a MAC (Media Access Control)-LSI used in Ethernet® are output to a data driven processor, the data driven processor can detect that the input packet of Ethernet® currently under processing includes data corresponding to the last sequence of a frame only after a next frame is input. Thus, it is necessary to temporarily write the input packet into a memory, as the processing of the packet cannot be started until arrival of the next frame. This considerably impairs parallelism that is an advantage of the data driven processor, leading to reduction of throughput.

Further, when frame data of Ethernet® having been processed by the data driven processor are to be output to the MAC-LSI, it is necessary to output to the MAC-LSI a control signal informing of the end of transmission corresponding to the last sequence of a frame. In this case, again, the data driven processor cannot output the control signal to the MAC-LSI until a next frame is detected. As such, parallelism as the advantage of the data driven processor is considerably degraded, resulting in reduced throughput.

Still further, a data driven processor can output information only in the packet format. Thus, to output an external synchronization signal, it is necessary to use a part of a tag as the external synchronization signal, or store control data for controlling the external synchronization signal in a packet and output the same. This increases the number of bits in the tag as well as the number of packets to be processed, leading to a decrease of processing speed.

### SUMMARY OF THE INVENTION

A first object of the present invention is to provide a data input device and method of generating a packet for a data driven processor from variable length data and outputting the same, to enable high-speed processing of the data driven processor.

A second object of the present invention is to provide a data output device and method capable of outputting a control signal without decreasing the processing speed of the data driven processor.

According to an aspect of the present invention, a data input device for transforming externally input variable length data to a packet for a data driven processor and outputting the packet to the data driven processor includes: a generation number generating portion generating a generation number; and a packet generating portion generating the packet having the generation number generated by the generation number generating portion, data of a prescribed length generated by dividing the variable length data, and a node number stored therein, wherein the packet generating portion stores the node number of a first value in a packet that contains data corresponding to a last sequence of a frame, and stores the node number of a second value different from the first value in a packet that contains data corresponding to a sequence other than the last sequence.

With this configuration, the data driven processor can execute a different program for the packet corresponding to the last sequence, which suppresses the decrease of the processing speed of the data driven processor.

Preferably, the packet generating portion generates the node number in accordance with an externally supplied signal indicating the last sequence of a frame, and stores the generated node number in the packet.

With this configuration, it is readily possible to generate the node number.

Preferably, the generation number generating portion includes a first counter that sequentially increments a value in response to an externally supplied signal indicating that data is valid so as to generate a sequence number, and a second counter that sequentially increments a value in response to a signal indicating the last sequence of a frame so as to generate a frame number.

With this configuration, the packet generating portion can readily generate a packet including the generation number.

Preferably, the data input device further includes a holding portion holding the node number, wherein the packet generating portion uses a value held in the holding portion as the node number for the packet containing the data corresponding to a sequence other than the last sequence, and uses an incremented value of the value held in the holding portion as the node number for the packet containing the data corresponding to the last sequence.

With this configuration, it is readily possible to inform the data driven processor as to whether the relevant data corresponds to the last sequence or not.

According to another aspect of the present invention, a data output device for externally outputting a packet input from a data driven processor as variable length data includes: a data extracting portion extracting and externally outputting data from the packet; and a signal generating portion externally outputting a signal indicating that the data corresponds to a last sequence of a frame when a predetermined instruction is stored in an opcode area included in the packet.

With this configuration, it is readily possible to generate a signal indicating that the data corresponds to the last sequence, so that the decrease of the processing speed of the data driven processor is suppressed.

Preferably, the signal generating portion generates and outputs a signal indicating that the data extracted by the data extracting portion is valid.

With this configuration, an external device can readily extract the data.

According to a further aspect of the present invention, a data input method for transforming externally input variable length data to a packet for a data driven processor and outputting the packet to the data driven processor includes: the step of generating a generation number; and the step of generating the packet having the generated generation number, data of a prescribed length generated by dividing the variable length data, and a node number stored therein. The step of generating the packet includes the step of storing the node number of a first value in a packet that contains data corresponding to a last sequence of a frame, and storing the node number of a second value different from the first value in a packet that contains data corresponding to a sequence other than the last sequence.

According to yet another aspect of the present invention, a data output method for externally outputting a packet input from a data driven processor as variable length data includes: the step of extracting and externally outputting data from the packet; and the step of externally outputting a signal indicating that the data corresponds to a last sequence of a frame when a predetermined instruction is stored in an opcode area included in the packet.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a conventional packet transformation circuit that generates a packet for a data driven processor from image data.

FIG. 2 shows a generation number that is included in a packet generated from a video signal.

FIG. 3 illustrates packets generated from a frame of Ethernet®.

FIG. 4 shows by way of example a system including a data input device and a data output device according to an embodiment of the present invention.

FIG. 5 is a block diagram showing a schematic configuration of an input circuit 1 according to the embodiment of the present invention.

FIG. 6 shows a generation number according to the embodiment of the present invention.

FIG. 7 shows a packet for a data driven processor 5 that is generated by the input circuit 1 according to the embodiment of the present invention.

FIG. 8 is a block diagram showing a schematic configuration of an output circuit 2 according to the embodiment of the present invention.

FIGS. 9A and 9B show by way of example frames of Ethernet® used in the embodiment of the present invention.

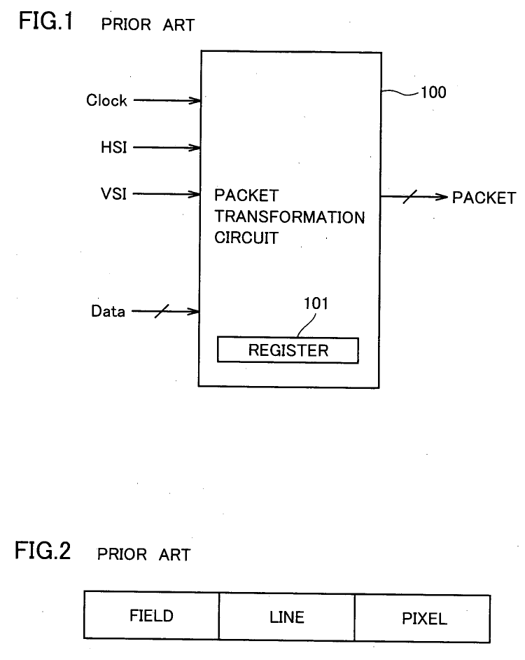

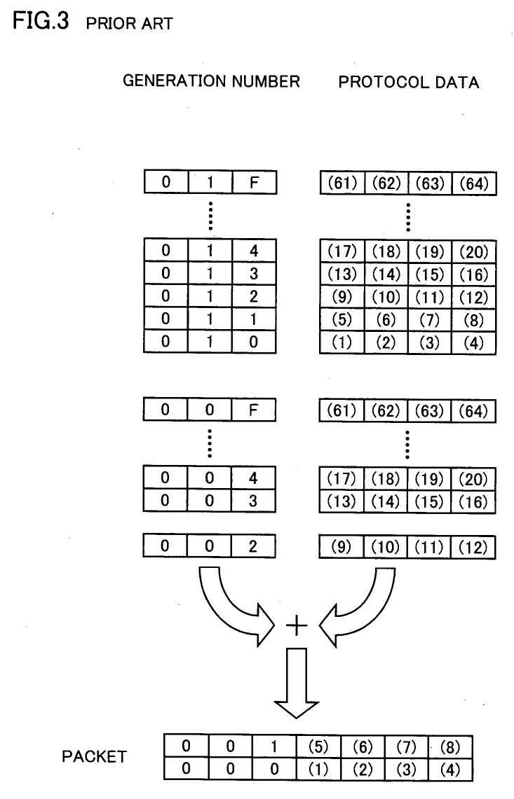

### DESCRIPTION OF THE PREFERRED EMBODIMENTS

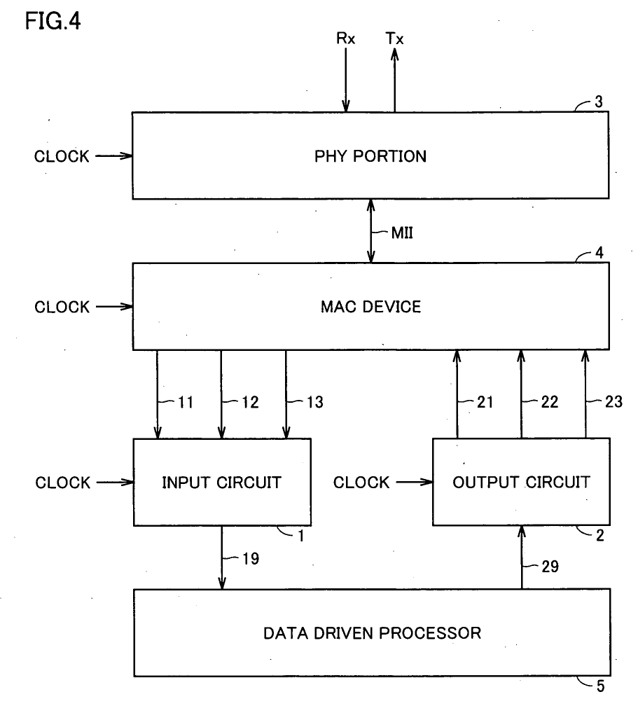

An example of a system including a data input device and a data output device according to an embodiment of the present invention is described with reference to FIG. 4. This system includes a PHY portion 3 that controls a physical layer of Ethernet®, a MAC device 4 that controls a MAC sub layer within a data link layer, a data driven processor 5, a data input device (hereinafter, referred to as “input circuit”) 1 that transforms data output from MAC device 4 into a packet for use in data driven processor 5, and a data output device (hereinafter, referred to as “output circuit”) 2 that transforms the packet output from data driven processor 5 into data to be output to MAC device 4.

Input circuit 1 receives a data signal 11, an input data valid signal 12 and a frame end signal 13 that are output from MAC device 4, and generates a packet output 19 for data driven processor 5 based on the signals received.

Output circuit 2, based on the packet output from data driven processor 5, outputs a data signal 21, an output data valid signal 22 and a frame transmission end signal to MAC device 4 for control thereof.

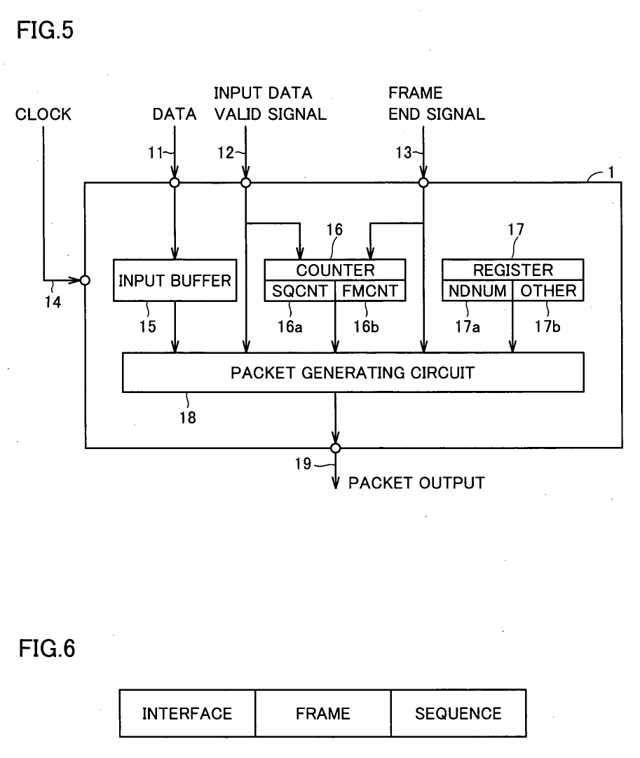

FIG. 5 shows a schematic configuration of input circuit 1 according to the embodiment of the present invention. Input circuit 1 includes an input buffer 15 that inputs and buffers data 11 from MAC device 4, a counter 16, a register 17, and a packet generating circuit 18.

Input data valid signal 12 is a signal of positive logic, which is at a high level (hereinafter, abbreviated as an “H level”) when valid data is being input, and at a low level (hereinafter, abbreviated as an “L level”) when valid data is not being input. Frame end signal 13 is a signal of positive logic indicating whether the valid data is of the last sequence of an Ethernet® frame, which is at an H level when the valid data corresponds to the last sequence, and at an L level when it does not.

Counter 16 includes SQCNT 16a that generates a sequence number, and FMCNT 16b that generates a frame number. SQCNT 16a is incremented in synchronization with input data valid signal 12 and reset by frame end signal 13. FMCNT 16b is incremented in synchronization with frame end signal 13, and returns to an initial value of e.g. “0” when it reaches a maximum value of valid bits.

Register 17 includes NDNUM 17a that holds a node number, and a register 17b that holds other information. NDNUM 17a has a node number preset thereto, which is used upon generation of a packet. The other register 17b includes information of interface number and others.

Data 11 is supplied to input buffer 15 in synchronization with a clock signal 14, and then input to packet generating circuit 18. When input data valid signal 12 is at an H level, packet generating circuit 18 extracts the data from input buffer 15 in synchronization with clock signal 14 to generate a packet. Upon generation of a packet, packet generating circuit 18 generates a generation number by using values held in SQCNT 16a, FMCNT 16b and the other register 17b as a sequence number, a frame number and an interface number, respectively, and stores the generation number in the packet.

FIG. 6 shows a generation number according to the embodiment of the present invention. The generation number includes a sequence number that indicates a corresponding word within an Ethernet® frame, a frame number that is assigned for each Ethernet® frame, and an interface number for specifying a corresponding interface when there are a plurality of interfaces for the device.

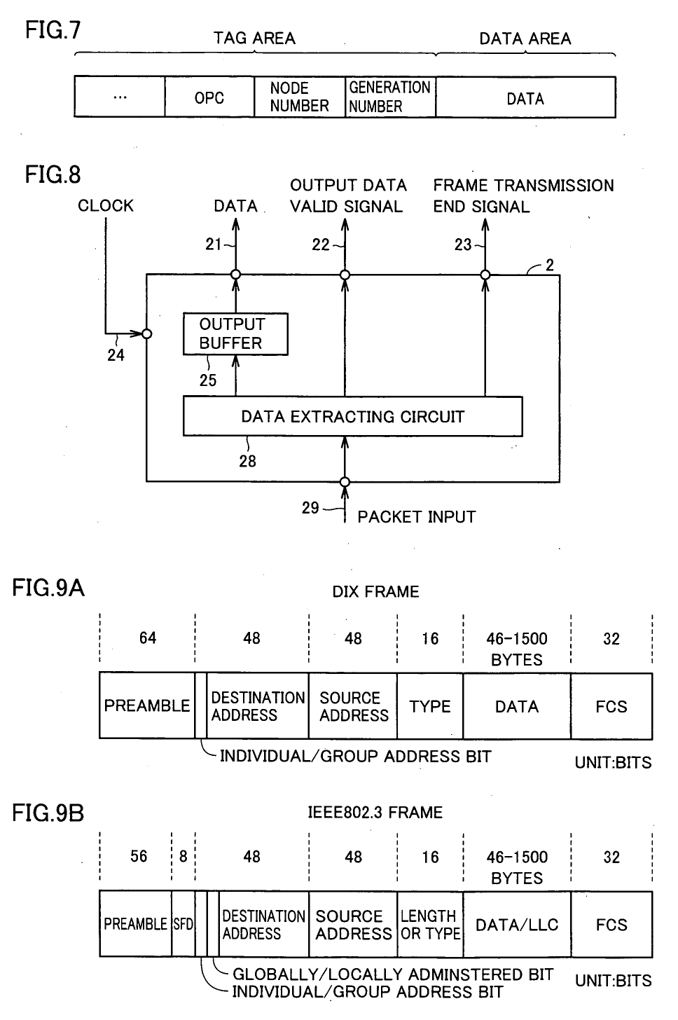

FIG. 7 shows a packet for data driven processor 5 that is generated by input circuit 1 according to the embodiment of the present invention. The packet includes a tag area and a data area. The tag area includes an opcode (OPC) indicative of a kind of instruction, a node number, and the generation number shown in FIG. 6. Since an instruction has not been fetched, invalid data is stored in the opcode area.

Upon generation of a packet, packet generating circuit 18 uses a value stored in NDNUM 17a as the node number to be stored in the packet, when frame end signal 13 is at an L level indicating that it is not the last sequence of a frame. When frame end signal 13 is at an H level indicating that it is the last sequence, packet generating circuit 18 increments the value stored in NDNUM 17a by 1, and stores the resultant value as the node number in the packet. As such, the packet corresponding to the last sequence of Ethernet® frame is assigned with a node number that is different from the node number being assigned to the other packets within the same frame, which enables a different program to be executed therefor.

FIG. 8 shows a schematic configuration of output circuit 2 according to the embodiment of the present invention. Output circuit 2 includes a data extracting circuit 28 that receives a packet input 29 from data driven processor 5 and extracts data from the packet, and an output buffer 25 that buffers the data extracted by data extracting circuit 28.

Data extracting circuit 28, when receiving packet input 29 from data driven processor 5, outputs the data to output buffer 25. It also generates and outputs an output data valid signal 22 to MAC device 4, in synchronization with the data 21 being output from output buffer 25 to MAC device 4. Output data valid signal 22 is a signal of positive logic indicating whether data 21 is valid or not, which is at an H level when valid data is being output, and at an L level when valid data is not being output.

Frame transmission end signal 23 is a signal of positive logic indicating whether the valid data is of the last sequence of an Ethernet® frame or not, which is at an H level when the valid data corresponds to the last sequence of the frame, and at an L level otherwise. Data extracting circuit 28 outputs frame transmission end signal 23 of an H level when a data output instruction OUTH is included in the opcode area of packet input 29 supplied from data driven processor 5, while it outputs frame transmission end signal 23 of an L level when another data output instruction OUTP is included therein. As such, a control signal (frame transmission end signal 23) informing of the last sequence of an Ethernet® frame can be output to MAC device 4 in accordance with an instruction of data driven processor 5.

FIGS. 9A and 9B illustrate examples of the Ethernet® frames used in the embodiment of the present invention. FIG. 9A shows a DIX frame. Packet generating circuit 18 sequentially stores data other than preamble (Preamble) and FCS (Frame Check Sequence) to packets, and outputs the packets to data driven processor 5.

FIG. 9B shows an IEEE 802.3 frame. Packet generating circuit 18 stores data other than preamble (Preamble), SFD (Start Frame Delimiter) and FCS to packets, and outputs the packets to data driven processor 5.

In the present embodiment, the case of generating a packet for a data driven processor from an Ethernet® frame has been explained. However, it is of course possible to apply the present invention to the case where a packet for the data driven processor is generated from other variable length data.

As described above, according to the data input device of the present embodiment, when frame end signal 13 is indicating the last sequence of a frame, packet generating circuit 18 stores a node number to the relevant packet that is different from the node number being stored in the packets other than the one corresponding to the last sequence. This allows data driven processor 5 to execute a particular program for the packet corresponding to the last sequence. Accordingly, data driven processor 5 does not need to wait to conduct processing until a next frame is input, which prevents a decrease in processing speed of data driven processor 5.

Further, according to the data output device of the present embodiment, data extracting circuit 28 outputs frame transmission end signal 23 of an H level if data output instruction OUTH is stored in the opcode area of the packet output from data driven processor 5, and outputs frame transmission end signal 23 of an L level when data output instruction OUTP is stored therein. This suppresses an increase in number of the bits in the tag as well as an increase in number of the packets to be processed, which also prevents the decrease of the processing speed of data driven processor 5.

Although the present invention has been described and illustrated in detail, it is clearly understood that the same is by way of illustration and example only and is not to be taken by way of limitation, the spirit and scope of the present invention being limited only by the terms of the appended claims.

1. A data input device for transforming externally input variable length data to a packet for a data driven processor and outputting the packet to said data driven processor, comprising:
a generation number generating portion generating a generation number; and
a packet generating portion generating the packet having the generation number generated by said generation number generating portion, data of a prescribed length generated by dividing the variable length data, and a node number stored therein, wherein
said packet generating portion stores the node number of a first value in a packet that contains data corresponding to a last sequence of a frame, and stores the node number of a second value different from the first value in a packet that contains data corresponding to a sequence other than the last sequence.

2. The data input device according to claim 1, wherein said packet generating portion generates the node number in accordance with an externally supplied signal indicating the last sequence of a frame, and stores the generated node number in the packet.

3. The data input device according to claim 1, wherein
said generation number generating portion includes
a first counter that sequentially increments a value in response to an externally supplied signal indicating that data is valid to generate a sequence number and
a second counter that sequentially increments a value in response to a signal indicating the last sequence of a frame to generate a frame number.

4. The data input device according to claim 1, further comprising a holding portion holding the node number, wherein
said packet generating portion uses a value held in said holding portion as the node number for the packet containing the data corresponding to a sequence other than the last sequence, and uses an incremented value of the value held in said holding portion as the node number for the packet containing the data corresponding to the last sequence.

5. A data output device for externally outputting a packet input from a data driven processor as variable length data, comprising:
a data extracting portion extracting and externally outputting data from said packet; and
a signal generating portion externally outputting a signal indicating that the data corresponds to a last sequence of a frame when a predetermined instruction is stored in an opcode area included in said packet.

6. The data output device according to claim 5, wherein said signal generating portion generates and outputs a signal indicating that the data extracted by said data extracting portion is valid.

7. A data input method for transforming externally input variable length data to a packet for a data driven processor and outputting the packet to said data driven processor, comprising the steps of:
generating a generation number; and
generating the packet having said generated generation number, data of a prescribed length generated by dividing the variable length data, and a node number stored therein;
said step of generating the packet including the step of storing the node number of a first value in a packet that contains data corresponding to a last sequence of a frame, and storing the node number of a second value different from the first value in a packet that contains data corresponding to a sequence other than the last sequence.

8. A data output method for externally outputting a packet input from a data driven processor as variable length data, comprising the steps of:
extracting and externally outputting data from said packet; and
externally outputting a signal indicating that the data corresponds to a last sequence of a frame when a predetermined instruction is stored in an opcode area included in said packet.
